(19) United States
(12) Patent Application Publication
(10) Pub. No.: US 2022/0009307 A1
(43) Pub. Date: Jan. 13, 2022

(54) THERMAL MANAGEMENT SYSTEM FOR A MOTOR-VEHICLE PASSENGER COMPARTMENT

(71) Applicant: Valeo Systemes Thermiques, Le Mesnil Saint-Denis Cedex (FR)

(72) Inventors: Daniel Neveu, Le Mesnil Saint-Denis Cedex (FR); Omar Zoubairi, Le Mesnil Saint-Denis Cedex (FR); Shivakumar Puttaswamy, Le Mesnil Saint-Denis Cedex (FR)

(73) Assignee: Valeo Systemes Thermiques, Le Mesnil-Saint-Denis (FR)

(21) Appl. No.: 17/291,860

(22) PCT Filed: Nov. 7, 2019
(86) PCT No.: PCT/FR2019/052661

§ 371 Date: May 6, 2021

(30) Foreign Application Priority Data
Nov. 9, 2018 (FR) 1860336

(51) Int. Cl. B60H 1/00; G05B 19/042; G06K 9/00

(52) U.S. Cl. CPC B60H 1/00742; B60H 1/00964; G05B 2219/2614; G06K 9/00369; G05B 19/042

(57) ABSTRACT

The invention relates to a thermal management system for a motor-vehicle passenger compartment, this system comprising a processing unit arranged to: —acquire: —a datum (BA) representative of the respiratory amplitude of the passenger,—and/or a datum (BR) representative of the respiratory rhythm of the passenger, —a datum (HR) representative of the cardiac rhythm of the passenger, —optionally a datum on the age of the passenger, —optionally a time-related datum (T) that is representative of the moment during the day, the time of day for example, —determining a datum (MET) representative of the metabolic activity of the passage on the basis of the aforementioned data, —preferably then determining a value of a thermal-comfort index (PMV) associated with the passenger in the passenger compartment on the basis of the datum (MET) representative of the metabolic activity of the passenger.

The invention relates to a motor-vehicle thermal management system. The invention further relates to a thermal management method implemented by such a thermal management system.

In a motor vehicle, it is known to provide for management of flow rates, temperatures and distribution of air blown by the various fans depending on outside temperature and insolation conditions. In certain vehicles, this may be combined with the activation of a heated steering wheel and/or a heated or cooled seat, and sometimes with surfaces, such as an elbow rest, that heat via contact.

It is almost unknown to detect and/or take into account the thermal state of passengers, with the exception of a few examples of use of infrared sensors that detect the surface temperature of the clothes of the passengers in order to better take into account initial conditions during the temporary welcome phase (whether the person is entering from a cold or hot environment) and the thermal equilibrium resulting from radiative and convective exchanges. In general, measurement of the thermal state of the interior is limited to a measurement of air temperatures combined with an insolation sensor.

More sophisticated approaches to comfort management have been proposed, these being based on new sensors, in particular infrared cameras, and new actuators, in particular radiant panels and/or actuators allowing localized air delivery.

The invention is intended, notably, to propose an improvement to the known thermal management systems.

Thus the invention relates to a thermal management system for a motor vehicle interior, the system comprising a processing unit arranged for:
acquiring a first datum representative of the clothing level of a passenger in the interior (Clo) and/or a second datum (MET) representative of the passenger's metabolic activity,
acquiring a third datum representative of the thermal environment of the passenger in the interior, notably a set of data for characterizing the thermal environment,
determining a value of a thermal comfort index (PMV) associated with the passenger in the interior on the basis of the data thus acquired.

The invention makes it possible to respond to rising expectations regarding comfort and well-being on board a vehicle, notably by increasing the capacity for adaptation to the requirements of each passenger.

The system according to the invention allows for the following aspects:
the capacity to adapt to the particular profile of each passenger, that is to say to take into account his particular expectations or preferences, together with his specific comfort field related to his personal profile (sex, age, ratio of muscle mass to fat, etc.)
the capacity to take into account each context of use or of the state of passengers that may affect thermal comfort, including clothing, metabolism (digestion, sport, time, etc), stress, fatigue, etc.
the capacity to take into account a wide variety of the thermal exchanges affecting the passengers, in terms of their nature (convection, radiation, contact) or location (head, neck, torso, arms, hands, back, thighs, legs, feet)

According to an aspect of the invention, the system comprises at least one sensor arranged to measure a parameter serving to determine at least one of the first, second and third data.

According to an aspect of the invention, the sensor is chosen from:
a camera, notably a DMS camera, arranged for observing a passenger in the interior,
an infrared dome formed by a wide angle infrared camera placed on a ceiling of the interior, for measuring the temperature of the walls and windows of the interior,
a sun sensor,
a temperature sensor at the outlet of an air conditioning unit or of an HVAC after the exchangers,
a sensor of the current air temperature in the interior.

A DMS (acronym of Driver Monitoring System) camera is a camera that operates in the near infrared and that may allow an image of the face and/or chest of the driver to be collected, irrespectively of the light level in the interior. By virtue of algorithms, and notably via physical analysis or the use of big data, it is possible to deduce much information such as: recognition of the identity of the passenger, evaluation of tiredness level, estimation of heart rate, recognition of items of clothing worn on the top part of the body.

According to an aspect of the invention, the system comprises an air-conditioning device, notably a HVAC, and the system is arranged to measure a parameter serving to determine the third datum representative of the thermal environment of the passenger in the interior, this parameter being related to the state of the air-conditioning device, and notably to the power of a blower of the air-conditioning device or the distribution of conditioned air from the air-conditioning device.

According to an aspect of the invention, the first datum (Clo) representative of the clothing level of the passenger in the interior corresponds to a clothing insulation of the clothes worn by the passenger.

According to an aspect of the invention, the system is arranged to process an image taken by a camera and to, from this image, determine the type of clothes (T-shirt and/or shirt and/or pullover and/or overcoat and/or scarf and/or hat) worn by the passenger, notably via image recognition, the system furthermore being arranged to determine clothing insulation from the type of clothes thus measured.

According to an aspect of the invention, the second datum (MET) representative of the metabolic activity of the passenger is dependent at least on a heart rate of the passenger, which is measured, notably, by a camera of the system, notably a DMS camera.

According to an aspect of the invention, this camera is arranged to observe changes in the color of the face of the passenger due to the movement of blood under the skin of the face, and the system measures heart rate based on these images.

According to an aspect of the invention, the second datum (MET) representative of the metabolic activity of the passenger is dependent on at least one physical characteristic of the passenger, which is measured, notably, by a camera of the system, and notably a DMS camera.

According to an aspect of the invention, the camera is arranged to measure, notably via image processing, physical characteristics of the passenger and notably his sex, age, height and volume. It is possible to deduce weight therefrom.

According to an aspect of the invention, the second datum (MET) representative of the metabolic activity of the passenger is dependent at least on a heart rate of the passenger and at least on one physical characteristic of the passenger.

According to an aspect of the invention, the second datum (MET) representative of the metabolic activity of the passenger corresponds to a thermal power per unit area produced by the passenger.

According to an aspect of the invention, the system is arranged to, from the temperatures of the walls and/or windows measured by a sensor, notably an infrared dome, to compute radiative temperature for at least one part, and notably a plurality of parts, of the body of the passenger, such as his head, chest, back, legs, calves, feet, and/or arms.

According to an aspect of the invention, the computation is carried out for at least six different body parts, and notably at least ten different body parts such as the head, neck, torso, arms, hands, back, bottom, thighs, legs and feet.

According to an aspect of the invention, the system is arranged to estimate the temperature of the air making contact with a part of the body of the passenger, and notably a plurality of parts of the body of the passenger, notably his head, chest, back, legs, calves, feet, and/or arms, notably based on the power of an air blower and/or of the distribution of the HVAC and/or of the temperature of the blown air and the temperature of the interior, notably on the basis of charts.

According to an aspect of the invention, the system is arranged, on the basis of the HVAC distribution and/or of the power of the air blower, to estimate, notably using charts, the speed of the air making contact with one part or a plurality of parts of the body of the passenger.

According to an aspect of the invention, the system is arranged to acquire characteristics of the HVAC, such as the positions of the shutters and a characteristic of the blower, with a view to estimating the air speed about the passengers.

According to an aspect of the invention, these temperatures and/or speeds are used to compute the third datum representative of the thermal environment of the passenger in the interior.

According to an aspect of the invention, the system is arranged to estimate the total thermal power (P_tot_theoritical) exchanged by the passenger with his environment by estimating the thermal power exchanged by each part of his body, notably his head, chest, back, legs, calves, feet and arms.

According to an aspect of the invention, the exchanged powers are dependent on the local air speed, on the local air temperature, on the local radiative temperature, on the surface area of the passengers, on the clothing level (Clo) of the passenger, and on the second datum (MET) representative of the metabolic activity of the passenger.

According to an aspect of the invention, the system is arranged to compare the total thermal power (P_tot_theoritical) exchanged with the environment with the theoretical power generated by the metabolism of the passengers, and, by multiplying this power difference by a coefficient, to determine a value of the thermal comfort index (PMV).

According to an aspect of the invention, this model can then be used to estimate the instantaneous comfort of the passengers. Set points may also be defined for the thermal actuators in order to ensure passenger comfort. Adjustment of the thermal system is thus personalized.

Contrary to known adjustments, which are based exclusively on parameters extraneous to the passengers (cab temperature, outside temperature, insolation), the invention preferably uses both external data and passenger characteristics. This enables thermal requirement to be refined to ensure thermal comfort for the passengers.

The invention also relates to a method of managing thermal comfort in a motor vehicle interior using an estimation model of the thermal sensations and thermal comfort based on a calculation of the heat exchanges on different parts of the body and the analysis of the resulting equilibrium temperatures and power budgets, characterized in that the method simultaneously determines, for the purpose of estimating a comfort index,
the metabolic activity of the passenger(s), based on measurement data and/or on a predetermined estimation model,
the clothing level of the passenger(s), based on measurement data and/or on a predetermined estimation model,
the exchanges by convection, radiation and contact with the passenger(s), recorded in at least six separate areas of the body.

According to an aspect of the invention, the method is arranged to take into account heat exchange by respiration, sweating and perspiration, which depends on the ambient humidity and temperature and on metabolism, to estimate a comfort index.

According to an aspect of the invention, metabolic activity is determined depending on the date and/or time, sex, age and other personal characteristics of the passenger, and on the datum or knowledge of their current or previous activities.

According to an aspect of the invention, the method is arranged to take into account variations in time, or between parts of the face, of the skin temperature measured by an infrared camera.

According to an aspect of the invention, the method is arranged to take into account an estimate of a local and global thermal sensation based on the datum of skin temperatures recorded as the reference for comfort in each part of the body, and based on a calculation of the heat deficit resulting from a budget of local and global exchanges found with these temperatures.

According to an aspect of the invention, the method is arranged to take into account a chart of skin temperatures recorded as the comfort reference in the form of values tabulated and/or modeled and/or found by learning, on the basis of the profile and preferences of each passenger, the environmental conditions and the context of use.

According to an aspect of the invention, the method is arranged to take into account an estimate of global thermal comfort based on the application of a formula that combines and weights the effect of the difference in each part of the body between the equilibrium skin temperature and the comfort reference temperature, as well as the variation of this difference over time.

According to an aspect of the invention, the method is arranged to take into account coefficients for weighting the effect of each term (the difference between the equilibrium temperatures and the reference temperature and/or its local variation) in the form of values tabulated and/or modeled and/or found by learning, as a function of the profile and preferences of each passenger, the environmental conditions and the context of use.

As a general rule, in order to monitor and/or predict the thermal comfort of a passenger in the vehicle, it is necessary to estimate the person's metabolic activity, by using a datum (MET) representative of the metabolic activity as the input datum of a thermophysiological model such as Fanger's model. This model will make it possible to evaluate simultaneously the thermal sensations and the thermal comfort of the person. The thermal sensation is the expression of the person's thermal perception, for example hot, neutral or cold. The thermal comfort is the expression of the person's satisfaction with respect to this thermal perception, for example pleasant or unpleasant, on the basis of the person's requirements for heat and cold.

To improve this model, the present invention makes it possible to measure metabolic activity and to understand the most influential factors.

The value of a thermal comfort index (PMV) may be defined as being:

PMV=Coef (A. MET)×(A. MET−DT)

where

MET is a datum representative of the metabolic activity related to the person's weight (in W/kg or kCal/hr/kg)

A is a conversion factor to relate the person's metabolic activity to the surface of the body participating in the external heat exchanges (A. MET, in W/m2)

Coef is an influence coefficient which is a function of A.MET

DT is a value of heat absorption or dissipation resulting from the heat exchanges with the external environment

The known models for predicting the value of MET give rise to significant errors in the evaluation of the thermal sensation.

The difficulty lies in the fact that metabolic activity depends on numerous parameters, both personal (sex, age, stoutness of build, hormones, etc.), affecting the value of the basal metabolic activity at rest, and contextual, related to physical or cognitive activity (running, walking, driving, metal concentration, stress, activity of sympathetic and parasympathetic nervous systems). Other physiological mechanisms, such as thermogenesis (shivering, vasoconstriction, digestion) also affect the metabolism.

The present invention proposes to identify a set of the most relevant parameters to be used to estimate the metabolism with sufficient accuracy, together with associated means of measurement or prediction.

Thus the present invention relates to a thermal management system for a motor vehicle interior, the system comprising a processing unit arranged for:
acquiring:
   a datum (BA) representative of the passenger's respiratory amplitude (the volume of air drawn in at each respiration),
   a datum (BR) representative of the passenger's respiratory rate (number of respirations per minute)
   a datum (HR) representative of the passenger's heart rate (number of beats per minute)
   optionally, a datum on the passenger's age,
   optionally, a datum (T) on the time that is representative of the moment during the day, for example the hour of the day,
determining a datum (MET) representative of the passenger's metabolic activity on the basis of the aforesaid data,
preferably, proceeding to determine a value of a thermal comfort index (PMV) associated with the passenger in the interior, on the basis of the datum (MET) representative of the passenger's metabolic activity.

The applicant has discovered, in an entirely positive way, in a panel of persons, that these data for calculating the passenger's metabolic activity (MET) enable a much more precise estimate of this activity (MET) to be achieved.

The invention enables the most dependent variables and the associated default values to be found, for the purpose of estimating the activity of the metabolism and predicting the associated accuracy and error of the model on the basis of the available data or the available measurements.

According to an aspect of the invention, the metabolic activity (MET) is also determined on the basis of the passenger's sex.

According to an aspect of the invention, the metabolic activity (MET) is also determined on the basis of the passenger's body mass index (BMI). This index is, notably, equal to the passenger's weight divided by the square of his height.

According to an aspect of the invention, the system comprises a sensor, of either the contact or contactless type, for supplying the datum on the heart rate.

This sensor may be a sensor arranged for being worn by the passenger, for example a watch.

According to an aspect of the invention, the system comprises a sensor, of either the contact or contactless type, for supplying the datum on the respiratory rate and/or the respiratory amplitude.

This sensor may be a sensor arranged for being worn by the passenger, for example a watch.

According to an aspect of the invention, the system is arranged for determining the sex and/or the age of the passenger, these data preferably being automatically identified by a recognition algorithm, preferably using one or more frontal cameras and a trained model, or, notably, data that are input by the passenger, preferably in a set of profiles.

According to an aspect of the invention, the system is arranged for determining the weight and/or the height of the passenger, these data preferably being automatically identified by a recognition algorithm, preferably using one or more cameras and a trained model, or, notably, data that are input by the passenger, preferably in a set of profiles.

According to an aspect of the invention, the system is arranged so that the metabolism model can be adjusted, on the basis of the user's profile, for the region or for the make or model of vehicle.

According to an aspect of the invention, the system is arranged so that the level of the metabolism model can be updated over the air ?? using as the vehicle or the passenger as a reference. The direct updating could be carried out using the connectivity of the vehicle or the connectivity of the passengers.

According to an aspect of the invention, the system is arranged so that the metabolism model can be activated on request or by subscription.

Notably, the invention is particularly well adapted to the following cases of use:
managing the passenger's comfort in summer immediately after running on foot,
managing the comfort of a passenger having a high body mass index,
managing the comfort of the passenger immediately after reaction to a stressful situation, for example a risk of accident,
managing comfort after lunchtime,
managing the thermal comfort of men and women differently,
managing the thermal comfort of young and old persons differently

The equations for calculating the value of MET may be of four types: on the one hand, an equation for men and an equation for women, and, on the other hand, an equation for situations with a low heart rate (HR<transition HR) and an equation for situations with a high heart rate (HR>transition HR), the “transition HR” between the two equations depending on physiological parameters specific to each passenger (sex, age and BMI if known).

These equations may be of the polynomial type.

The equation may, for example, be written as follows:

MET=a1×(HR)^{a2}+b1×(BR)^{b2}+c1×(BA)^{c2}+d1×(Age)^{d2}+e1×(T)^{e2}

The coefficients a1, b1, c1, d1 and e1, and a2, b2, c2, d2 and e2 will be a function of the gender (male or female) and of the range of heart rate (lower than or higher than the transition HR).

If BA is unknown, a replacement equation may be used, in which only BR is active, with a dedicated coefficient and exponent bc1 and bc2:

MET=a1×(HR)^{a2}+bc1×(BR)^{bc2}+d1×(Age)^{d2}+e1×(T)^{e2}

If “Age” and/or “T” are unknown, a constant “de” may be used in place of one or both of the omitted terms:

MET=a1×(HR)^{a2}+11×(BR)^{b2}+c1×(BA)^{c2}de

The equation makes use of the following data:
a datum (BA) representative of the passenger's respiratory amplitude,
a datum (BR) representative of the passenger's respiratory rate,
a datum (HR) representative of the passenger's heart rate,
a datum on the passenger's age (Age),
a datum (T) on the time that is representative of the moment during the day, for example the hour of the day.

30

The present invention also relates to a method of thermal management for a motor vehicle interior, the method comprising the following steps:
acquiring:
   a datum (BA) representative of the passenger's respiratory amplitude (the volume of air drawn in at each respiration),
   a datum (BR) representative of the passenger's respiratory rate (number of respirations per minute),
   a datum (HR) representative of the passenger's heart rate (number of beats per minute)
   optionally, a datum on the passenger's age,
   optionally, a datum (T) on the time that is representative of the moment during the day, for example the hour of the day,
determining a datum (MET) representative of the passenger's metabolic activity on the basis of the aforesaid data,
preferably, proceeding to determine a value of a thermal comfort index (PMV) associated with the passenger in the interior, on the basis of the datum (MET) representative of the passenger's metabolic activity.

The invention will be better understood and other details, features and advantages of the invention will become apparent on reading the following description, which is given by way of non-limiting example with reference to the appended drawings, in which:

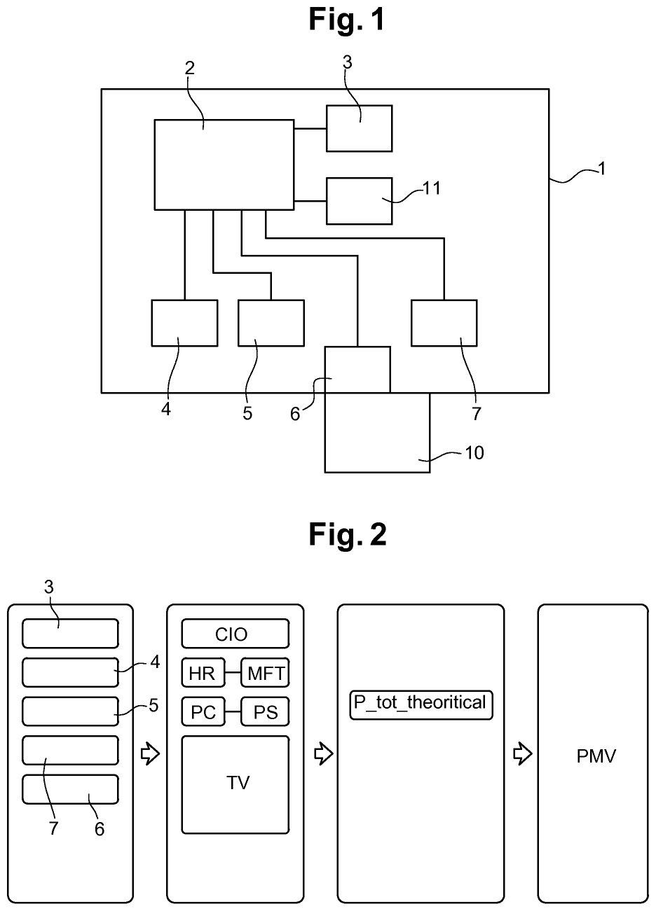

FIG. 1 shows, in a schematic and partial manner, a thermal system according to the invention,

FIG. 2 shows steps in the method of managing thermal comfort in the system of FIG. 1,

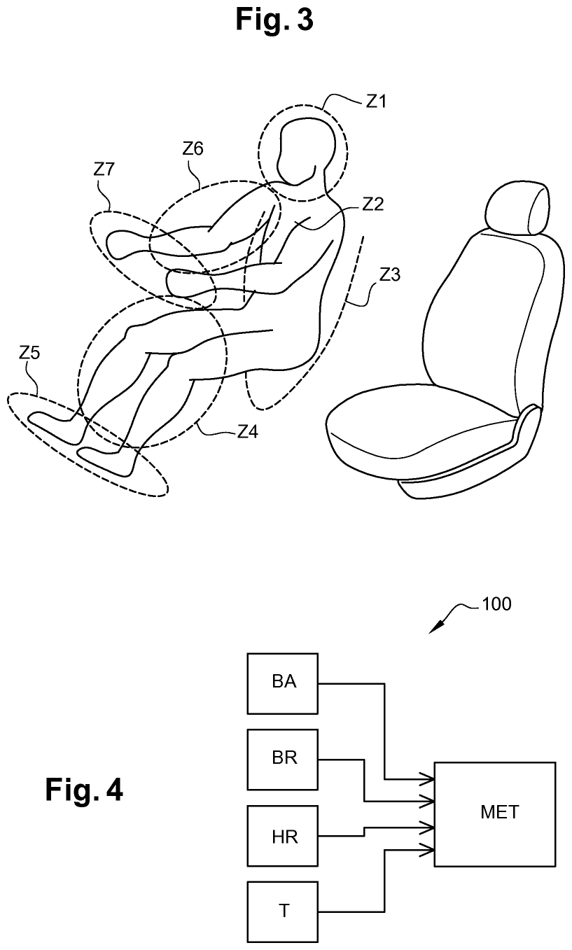

FIG. 3 shows the different areas of the passenger involved in the method of FIG. 2.

FIG. 4 shows a processing system for embodiments disclosed herein.

FIG. 1 shows a thermal management system 1 for a motor vehicle interior, the system comprising a processing unit 2 arranged for:
acquiring a first datum (Clo) representative of the clothing level of a passenger in the interior,
acquiring a second datum (MET) representative of the passenger's metabolic activity,
acquiring a third datum representative of the thermal environment of the passenger in the interior,
determining a value of a thermal comfort index (PMV) associated with the passenger in the interior on the basis of the three data thus acquired.

The system comprises a plurality of sensors arranged to measure a plurality of parameters serving to determine the first, second and third data.

These sensors comprise:
a DMS camera 3 arranged for observing a passenger in the interior,
an infrared dome 4 formed by a wide angle infrared camera placed on a ceiling of the interior, for measuring the temperature of the walls and windows of the interior,
a sun sensor 5,
an air temperature sensor 6 at the outlet of an air conditioning unit or of the HVAC 10,
a sensor 7 of the current air temperature in the interior.

The system 1 is arranged to measure a parameter serving to determine the third datum representative of the thermal environment of the passenger in the interior, this parameter being related to the state of the air-conditioning device, and notably to the power of a blower of the air-conditioning device or the distribution of conditioned air from the air-conditioning device.

The first datum (Clo) representative of the clothing level of the passenger in the interior corresponds to a measured clothing insulation of the clothes worn by the passenger.

To this end, the system 1 is arranged to process an image taken by the camera 3 and to, from this image, determine the type of clothes (T-shirt and/or shirt and/or pullover and/or overcoat and/or scarf and/or hat) worn by the passenger notably via image recognition, the system 1 furthermore being arranged to determine clothing insulation from the type of clothes thus measured.

The second datum (MET) representative of the metabolic activity of the passenger depends on the heart rate HR of the passenger, which is notably measured by the camera 3, as may be seen in FIG. 3. This camera 3 is arranged to observe changes in the color of the face of the passenger due to the movement of blood under the skin of the face, and the system measures heart rate based on these images.

The second datum (MET) representative of the metabolic activity of the passenger is dependent on a physical characteristic of the passenger, which is measured by the camera 6 with a view to determining, by image processing, physical characteristics PC of the passenger, notably his sex, age, size and volume, and indirectly his weight.

The second datum MET representative of the metabolic activity of the passenger corresponds to a thermal power per unit area PS produced by the passenger, which is deduced using the datum PC.

A plurality of data (MET) representative of the metabolic activity of the passenger are used.

The system 1 is arranged to, from the temperatures of the walls and/or window, which are measured by the infrared dome 4, compute the radiative temperature of a plurality of parts of the body of the passenger, such as his head Z1, chest Z2, back Z3, legs Z4, feet Z5, arms Z6 and hands Z7, as shown in FIG. 3.

The system 1 is arranged to estimate the temperature of the air making contact with a part of the body of the passenger, and notably a plurality of parts of the body of the passenger, notably his head, chest, back, legs, calves, feet, and/or arms, notably based on the power of an air blower and/or of the distribution of the HVAC and/or of the temperature of the blown air and the temperature of the interior, notably on the basis of charts.

The system 1 is arranged, on the basis of the HVAC distribution and/or of the power of the air blower, to estimate, notably using charts, the speed of the air making contact with one part or a plurality of parts of the body of the passenger.

These temperatures and/or speeds TV are used to compute the third datum representative of the thermal environment of the passenger in the interior.

The system 1 is arranged to estimate the total thermal power (P_tot_theoritical) exchanged by the passenger with his environment by estimating the thermal power exchanged by each part of his body, notably his head, chest, back, legs, calves, feet and arms. This total exchanged thermal power (P_tot_theoritical) is dependent on the data Clo, Met and PS.

Specifically, the exchanged powers are dependent on the local air speed, on the local air temperature, on the local radiative temperature, on the surface area of the passengers, on the clothing level (Clo) of the passenger, and on the second datum (MET) representative of the metabolic activity of the passenger.

The system 1 is arranged to compare the total thermal power (P_tot_theoritical) exchanged with the environment with the theoretical power generated by the metabolism of the passengers, and, by multiplying this power difference by a coefficient, to determine a value of the thermal comfort index (PMV).

According to an aspect of the invention, this model can then be used to estimate the instantaneous comfort of the passengers. Set points may also be defined for the thermal actuators in order to ensure passenger comfort. Adjustment of the thermal system is thus personalized.

The method is able to take into account heat exchange by respiration, sweating and perspiration, which depends on the ambient humidity and temperature and on metabolism, to estimate a comfort index.

Metabolic activity is determined depending on the date and/or time, sex, age and other personal characteristics of the passenger, and on the datum or knowledge of their current or previous activities.

In the example illustrated in FIG. 4, the thermal management system comprises a processing unit 100 arranged for:
acquiring:
   a datum (BA) representative of the passenger's respiratory amplitude,
   a datum (BR) representative of the passenger's respiratory rate,
   a datum (HR) representative of the passenger's heart rate,
   optionally, a datum on the passenger's age,
   optionally, a datum (T) on the time that is representative of the moment during the day, for example the hour of the day,
determining a datum (MET) representative of the passenger's metabolic activity on the basis of the aforesaid data,
preferably, proceeding to determine a value of a thermal comfort index (PMV) associated with the passenger in the interior, on the basis of the datum (MET) representative of the passenger's metabolic activity.

The metabolic activity (MET) is also determined on the basis of the passenger's sex.

The metabolic activity (MET) is also determined on the basis of the passenger's body mass index (BMI), if known.

The system comprises a sensor, of either the contact or contactless type, for supplying the datum on the heart rate.

This sensor may be a sensor arranged for being worn by the passenger, for example a watch.

The system comprises a sensor, of either the contact or contactless type, for supplying the datum on the respiratory rate and/or the respiratory amplitude.

This sensor may be a sensor arranged for being worn by the passenger, for example a watch.

According to an aspect of the invention, the system is arranged for determining the sex and/or the age of the passenger, these data preferably being automatically identified by a recognition algorithm, preferably using one or more frontal cameras and a trained model, or, notably, data that are input by the passenger, preferably in a set of profiles.

According to an aspect of the invention, the system is arranged for determining the weight and/or the height of the passenger, these data preferably being automatically identified by a recognition algorithm, preferably using one or more dome cameras and a trained model, or, notably, data that are input by the passenger, preferably in a set of profiles.

The equations for calculating the value of MET may be of four types: on the one hand, an equation for men and an equation for women, and, on the other hand, an equation for situations with a low heart rate (HR<transition HR) and an equation for situations with a high heart rate (HR>transition HR), the “transition HR” between the two equations depending on physiological parameters specific to each passenger (sex, age and BMI if known).

These equations may be of the polynomial type.

The equation may, for example, be written as follows:

MET=a1×(HR)^{a2}+b1×(BR)^{b2}+c1×(BA)^{c2}+d1×(Age)^{d2}+e1×(T)^{e2}

The coefficients a1, b1, c1, d1 and e1, and a2, b2, c2, d2 and e2, are a function of the gender (male or female) and of the range of heart rate (lower than or higher than the transition HR).

If BA is unknown, a replacement equation may be used, in which only BR is active, with a dedicated coefficient and exponent bc1 and bc2:

MET=a1×(HR)^{a2}+bc1×(BR)^{bc2}+d1×(Age)^{d2}+e1×(T)^{e2}

If “Age” and/or “T” are unknown, a constant “de” may be used in place of one or both of the omitted terms:

MET=a1×(HR)^{a2}+b1×(BR)^{b2}+c1×(BA)^{c2}+de

The equation makes use of the following data:
a datum (BA) representative of the passenger's respiratory amplitude,
a datum (BR) representative of the passenger's respiratory rate,
a datum (HR) representative of the passenger's heart rate,
a datum (T) on the time that is representative of the moment during the day, for example the hour of the day.

The datum MET found in this way may then be used in the system described in the embodiment of FIGS. 1 and 2, for determining the value PMV.

1. A thermal management system for a motor vehicle interior, the system comprising:
a processing unit arranged for acquiring:
a datum representative of the passenger's respiratory amplitude,
a datum representative of the passenger's respiratory rate,
a datum representative of the passenger's heart rate,
optionally, a datum on the passenger's age,
optionally, a datum on the time that is representative of the moment during the day, for example the hour of the day,
determining a datum representative of the passenger's metabolic activity on the basis of the aforesaid data,
proceeding to determine a value of a thermal comfort index associated with the passenger in the interior, on the basis of the datum representative of the passenger's metabolic activity.

2. The system as claimed in claim 1, wherein the metabolic activity is also determined on the basis of the passenger's sex.

3. The system as claimed in claim 1, wherein the metabolic activity is also determined on the basis of the passenger's body mass index.

4. The system as claimed in claim 1, wherein the system comprises a sensor, of either the contact or contactless type, for supplying the datum on the heart rate.

5. The system as claimed in claim 1, wherein the system comprises a sensor, of either the contact or contactless type, for supplying the datum on the respiratory rate and/or the respiratory amplitude.

6. The system as claimed in claim 1, wherein the system is arranged for determining the sex and/or the age of the passenger, these data being automatically identified by a recognition algorithm, using one or more frontal cameras and a trained model, or data that are input by the passenger, in a set of profiles.

7. The system as claimed in claim 1, wherein the system is arranged for determining the weight and/or the height of the passenger, these data being automatically identified by a recognition algorithm, using one or more dome cameras and a trained model, or notably, data that are input by the passenger, in a set of profiles.

8. The system as claimed in claim 1, wherein the system is arranged so that the metabolism model can be adjusted, on the basis of the user's profile, for the region or for the make or model of vehicle.

9. A method of thermal management for a motor vehicle interior, the method comprising:
acquiring:
a datum representative of the passenger's respiratory amplitude,
a datum representative of the passenger's respiratory rate,
a datum representative of the passenger's heart rate,
a datum on the passenger's age,
a datum on the time that is representative of the moment during the day,
determining a datum representative of the passenger's metabolic activity on the basis of the aforesaid data; and
proceeding to determine a value of a thermal comfort index associated with the passenger in the interior, on the basis of the datum representative of the passenger's metabolic activity.

10. The method as claimed in claim 9, used for one of the following cases of utilization:
managing the passenger's comfort in summer immediately after running on foot,
managing the comfort of a passenger having a high body mass index,
managing the comfort of the passenger immediately after reaction to a stressful situation, for example a risk of accident,
managing comfort after lunchtime,
managing the thermal comfort of men and women differently,
managing the thermal comfort of young and old persons differently.
